(19) United States
(12) Patent Application Publication
(10) Pub. No.: US 2003/0075006 A1
(43) Pub. Date: Apr. 24, 2003

(54) Device for limiting movement of a body in relation to another

(76) Inventors: Paul Coffin, Fort Collins, CO (US); Robert L. Mueller, Windsor, CO (US); Morley C. Tobey JR., Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/028,875

(22) Filed: Oct. 22, 2001

(51) Int. Cl. G05G 1/00

(52) U.S. Cl. 74/577 SF

(57) ABSTRACT

A device for limiting the movement of one body relative to another. In one embodiment, a device for limiting the movement of a first body in relation to a second body is disclosed which includes a bendable piece of material, wherein the piece includes a first section and a second section contiguous to the first section, wherein the second section forms a first angle with respect to the first section, wherein the first angle is measured in a counter-clockwise direction from the first section, wherein the first angle is at least zero degrees and is less than 135 degrees when the piece is un-deflected, and wherein at least a portion of the first section is attachable to the second body.

### FIELD OF THE INVENTION

The present invention relates generally to movement mechanisms and more particularly to devices for limiting the movement of a body in relation to another.

### BACKGROUND OF THE INVENTION

In some applications, it is often desirable to provide a user access to the contents of a container such as a drawer but, for safety and other reasons, not permit him to completely remove the container from its assigned slot without releasing an interlock. One example of many such applications occurs in magnetic tape libraries. Tape libraries are used in computer systems as a convenient means of storage and retrieval of large amounts of data. The data is stored on magnetic tape with each tape mounted in a holder. The combined tape and holder are referred to as a tape cartridge. The tape cartridges are loaded onto trays within the tape library for storage and subsequent selection. When data from a particular tape is required, the tray on which its cartridge is stored is moved by a magnetic tape autochanger, which is a component of the tape library, to the vicinity of a magnetic tape reader. The tape cartridge is removed from its tray and positioned in the tape reader where its data is then read by the tape reader.

In such systems, it is typically necessary to provide the user access to the tape cartridges for cartridge loading and unloading. As an example, individual cartridges or groups of cartridges may need to be removed from the autochanger as they wear-out or, for data safety, stored off-site.

In typical systems, when a user desires to add or remove a particular cartridge he does so by first requesting it via either the front panel of the autochanger or the host computer. The autochanger then moves the tray on which the selected cartridge resides to a special drawer, typically referred to as a mailbox, that the autochanger uses for such access. The system then actuates a solenoid so that the drawer can be partially opened thereby providing access to the cartridge.

An interlock is provided to inhibit complete removal of the drawer. For complete removal of the drawer, the interlock is first released. In typical autochangers this interlock comprises an expensive panel and/or computer-actuated solenoid.

### SUMMARY OF THE INVENTION

In one embodiment, a device for limiting the movement of a first body in relation to a second body is disclosed which includes a bendable piece of material, wherein the piece includes a first section and a second section contiguous to the first section, wherein the second section forms a first angle with respect to the first section, wherein the first angle is measured in a counter-clockwise direction from the first section, wherein the first angle is at least zero degrees and is less than 135 degrees when the piece is un-deflected, and wherein at least a portion of the first section is attachable to the second body.

### BRIEF DESCRIPTION OF THE DRAWINGS

The accompanying drawings provide visual representations which will be used to more fully describe the invention and can be used by those skilled in the art to better understand it and its inherent advantages. In these drawings, like reference numerals identify corresponding elements and:

FIG. 1A is a drawing of a device for limiting the movement of one body in relation to another as described in various representative embodiments consistent with the teachings of the invention.

FIG. 1B is a drawing of the device of FIG. 1A located in a first position for limiting the movement of one body in relation to another as described in various representative embodiments consistent with the teachings of the invention.

FIG. 1C is another drawing of the device of FIG. 1A located in a second position for limiting the movement of one body in relation to another as described in various representative embodiments consistent with the teachings of the invention.

FIG. 1D is a drawing of another embodiment of the device of FIG. 1A for limiting the movement of one body in relation to another with minimum value of first angle consistent with the teachings of the invention.

FIG. 2A is a drawing of another embodiment of the device for limiting the movement of one body in relation to another consistent with the teachings of the invention.

FIG. 2B is a drawing of the device of FIG. 2A located in the first position for limiting the movement of one body in relation to another as described in various representative embodiments consistent with the teachings of the invention.

FIG. 2C is another drawing of the device of FIG. 2A located in the second position for limiting the movement of one body in relation to another as described in various representative embodiments consistent with the teachings of the invention.

FIG. 2D is a drawing of anotther embodiment of the device of FIG. 2A for limiting the movement of one body in relation to another with minimum value of first angle consistent with the teachings of the invention.

FIG. 3A is a drawing of a further embodiment of the device for limiting the movement of one body in relation to another consistent with the teachings of the invention.

FIG. 3B is a drawing of the device of FIG. 3A located in the first position for limiting the movement of one body in relation to another as described in various representative embodiments consistent with the teachings of the invention.

FIG. 3C is another drawing of the device of FIG. 3A located in the second position for limiting the movement of one body in relation to another as described in various representative embodiments consistent with the teachings of the invention.

FIG. 4A is drawing of still another embodiment of the device for limiting the movement of one body in relation to another consistent with the teachings of the invention.

FIG. 4B is a drawing of the device of FIG. 4A located in the first position for limiting the movement of one body in relation to another as described in various representative embodiments consistent with the teachings of the invention.

FIG. 4C is another drawing of the device of FIG. 4A located in the second position for limiting the movement of one body in relation to another as described in various representative embodiments consistent with the teachings of the invention.

FIG. 5 is a drawing of an example application of an embodiment of the device for limiting the movement of one body in relation to another consistent with the teachings of the invention.

FIG. 6 is another drawing of the example application of FIG. 5 of the device for limiting the movement of one body in relation to another as described in various representative embodiments consistent with the teachings of the invention.

### DETAILED DESCRIPTION OF THE PREFERRED EMBODIMENTS

As shown in the drawings for purposes of illustration, the present patent document relates to a novel device for limiting the movement of one body in relation to another. In particular, a device is described which acts as an inexpensive interlock to limit movement of a body in relation to another. Such a device will be discussed in connection with its use in a tape library autochanger to inhibit complete removal of a drawer containing magnetic tape cartridges. For complete removal of the drawer, the interlock is easily released. Previous devices used as interlocks in such applications have relied upon expensive panel and/or computer actuated solenoids. The present patent document discloses a simpler, less expensive device. While the example shown is described in connection with a magnetic tape autochanger, the invention is not so limited.

In the following detailed description and in the several figures of the drawings, like elements are identified with like reference numerals.

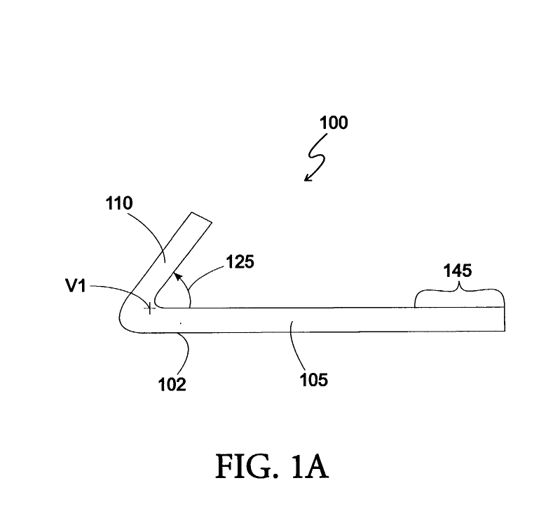

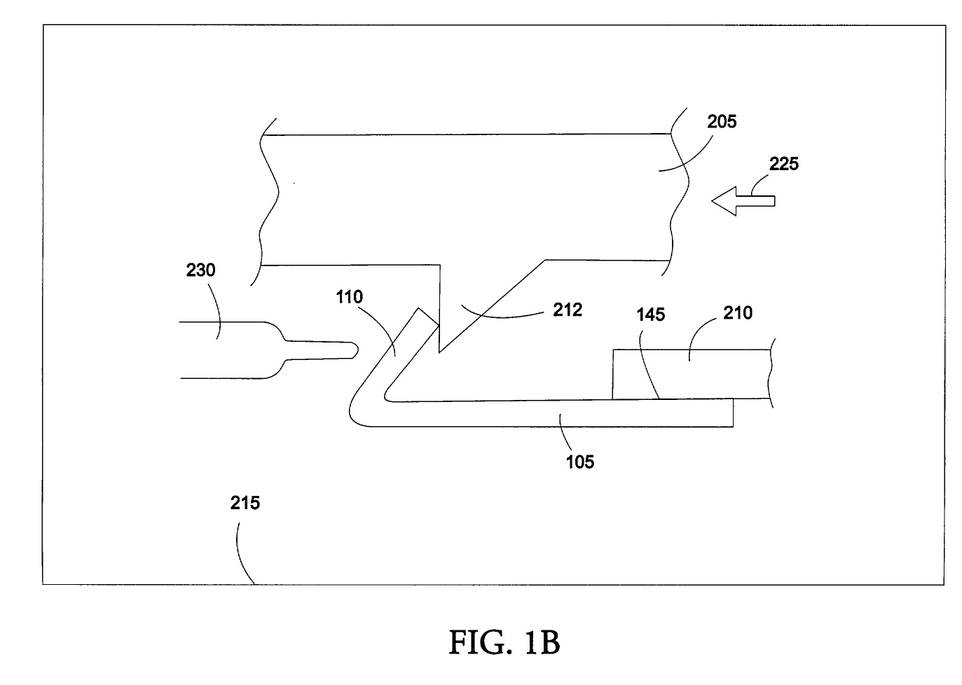

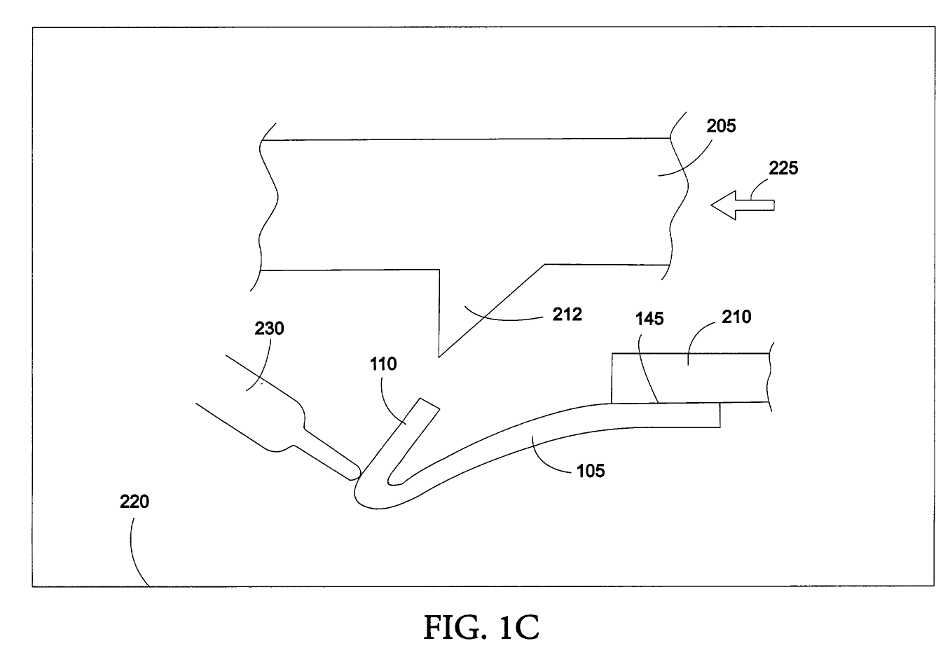

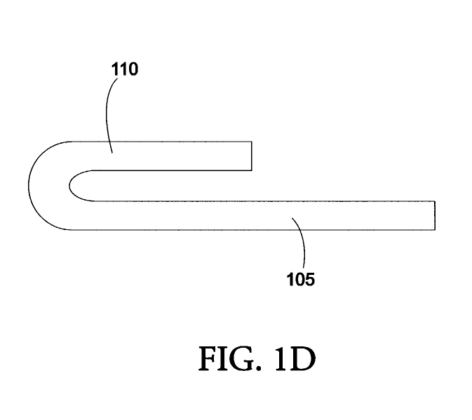

FIG. 1A is a drawing of a device 100 for limiting the movement of one body in relation to another as described in various representative embodiments consistent with the teachings of the invention. In a first representative embodiment as shown in FIG. 1A, the device 100, also referred to herein as lock spring 100 and as interlock 100, comprises a piece 102 of material which could be fabricated as a wire 102, a sheet stainless spring steel 102, a band 102, a molded part 102, or the like. The piece 102 comprises first and second sections 105,110. A distal portion of the first section 105 is referred to as a portion 145 in subsequent discussion.

In the un-deflected condition of FIG. 1A, a first angle 125 is formed between first and second sections 105,110 with vertex at first vertex V1. The first angle 125 is measured in a counter-clockwise direction from the first section 105.

FIG. 1B is a drawing of the device 100 of FIG. 1A located in a first position 215 for limiting the movement of one body in relation to another as described in various representative embodiments consistent with the teachings of the invention. In the representative embodiment of FIG. 1B, the lock spring 100 shown is that of the first representative embodiment of FIG. 1A and is attached to a second body 210 at portion 145. A first body 205 comprising a stop 212 is prevented from motion in a preselected direction 225 past the lock spring 100 by the impact of stop 212 against the second section 110. In a typical application, the first body 205 is constrained to movement along an axis parallel to that of the preselected direction 225 by tracks attached to the second body 210. With the lock spring 100 in the first position 215 as shown in FIG. 1B, the first body 205 is free to move in the direction opposite to the preselected direction 225 until restricted by other components of the second body 210 not shown in the figures. Also shown in FIG. 1B is a tool 230, which could be, for example, a screwdriver 230.

FIG. 1C is another drawing of the device 100 of FIG. 1A located in a second position 220 for limiting the movement of one body in relation to another as described in various representative embodiments consistent with the teachings of the invention. In FIG. 1C, the lock spring 100 has been moved to the second position 220 by a force applied by the tool 230 to the second section 110. In the second position 220, the second section 110 has been depressed far enough that it no longer impedes the movement of the first body 205 past the second body 210. The force required to move the lock spring 100 from the first position 215 to the second position 220 is preferably of a magnitude easily applied by hand and is, in some embodiments, less than one pound.

Practical minimum and maximum values for the first angle 125 are implementation-dependent. In general, however, characteristics of importance in the implementation are (1) for the lock spring 100 to impede, if not completely stop, motion of the first body 205 in the preselected direction 225 by impacting the stop 212, (2) for the tool 230 to be capable of accessing the second section 110 in order to deflect it from the first position 215 to the second position 220 when removing the first body 205 from its position relative to the second body 210, and (3) for the first body 205 to be able to move relatively freely in the opposite direction to that of the preselected direction 225 when replacing the first body 205 in position relative to the second body 210. The specific materials chosen for the stop 212 and for the lock spring 100, as well as the geometry chosen for the stop 212 will have a significant impact on the success in attaining the above important characteristics. A practical range for the first angle 125 is at least zero degrees and less than 135 degrees with typical, preferred value being 45 degrees.

FIG. 1D is a drawing of another embodiment of the device 100 of FIG. 1A for limiting the movement of one body in relation to another with minimum value of first angle 125 consistent with the teachings of the invention. In FIG. 1D, the first angle 125 is equal to zero degrees.

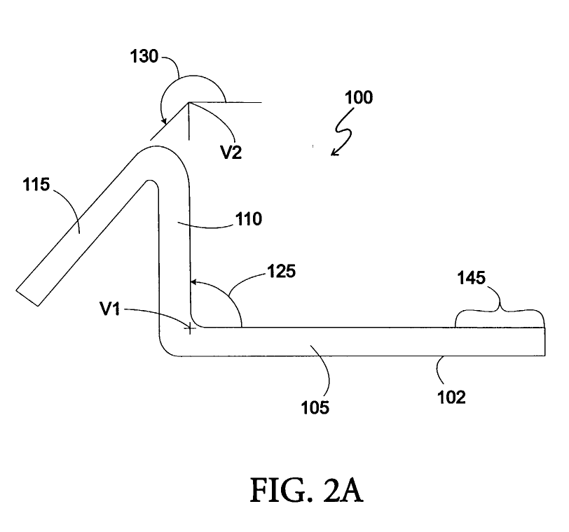

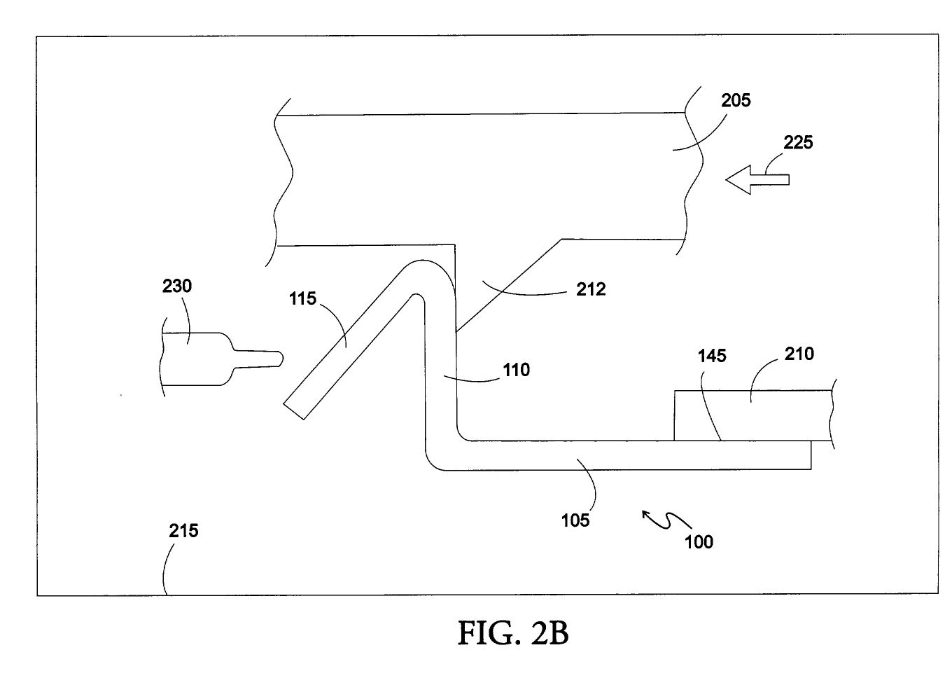

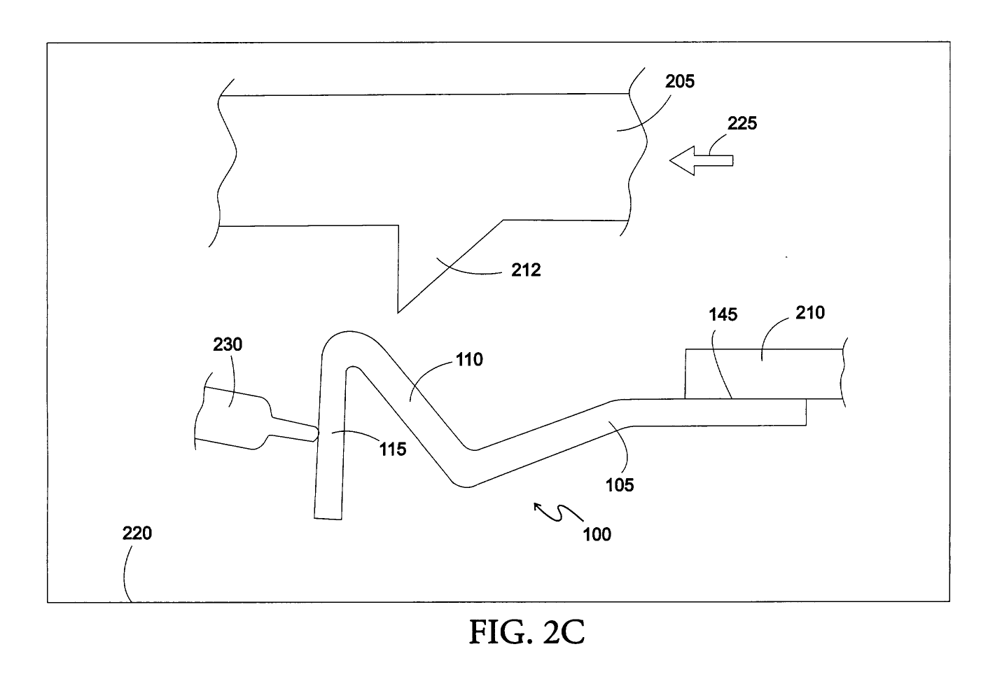

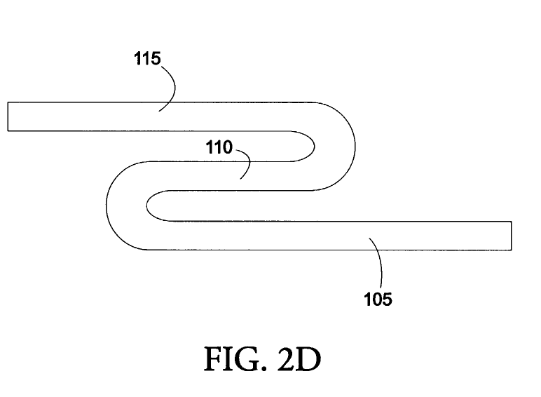

FIG. 2A is a drawing of another embodiment of the device 100 for limiting the movement of one body in relation to another consistent with the teachings of the invention. In a second representative embodiment as shown in FIG. 2A, the device 100, also referred to herein as lock spring 100 and as interlock 100, comprises a piece 102 of material which could be fabricated as a wire 102, sheet stainless spring steel 102, a band 102, a molded part 102, or the like. The piece 102 comprises first and second sections 105,110 and in addition a third section 115. A distal portion of the first section 105 is referred to as the portion 145 in subsequent discussion.

In the un-deflected position of FIG. 2A, the first angle 125 is formed between first and second sections 105,110 with vertex at first vertex V1. The first angle 125 is measured in a counter-clockwise direction from the first section 105. Also, in the un-deflected position of FIG. 2A, a second angle 130 is formed between parallel translation of the first section 105 and the third section 115 with vertex at second vertex V2. The second angle 130 is measured in a counter-clockwise direction from the parallel translation of the first section 105.

FIG. 2B is a drawing of the device 100 of FIG. 2A located in the first position 215 for limiting the movement of one body in relation to another as described in various representative embodiments consistent with the teachings of the invention. In the representative embodiment of FIG. 2B, the lock spring 100 shown is that of the second representative embodiment of FIG. 2A and is attached to the second body 210 at portion 145. The first body 205 comprising the stop 212 is prevented from motion in the preselected direction 225 past the lock spring 100 by the impact of stop 212 against the second section 110. In a typical application, the first body 205 is constrained to movement along an axis parallel to that of the preselected direction 225 by tracks attached to the second body 210. With the lock spring 100 in the first position 215 as shown in FIG. 2B, the first body 205 is free to move in the direction opposite to the preselected direction 225 until restricted by other components of the second body 210 not shown in the figures. Also shown in FIG. 2B is the tool 230, which could be, for example, the screwdriver 230.

FIG. 2C is another drawing of the device 100 of FIG. 2A located in the second position 220 for limiting the movement of one body in relation to another as described in various representative embodiments consistent with the teachings of the invention. In FIG. 2C, the lock spring 100 has been moved to the second position 220 by force applied by the tool 230 to the third section 115. In the second position 220, the second section 110 has been depressed far enough that it no longer impedes the movement of the first body 205 past the second body 210. For the second representative embodiment shown in FIG. 2A, the force used to move the lock spring 100 to the second position 220 is applied to the third section 115 or to the intersection of the second and third sections 110,115.

Again practical minimum and maximum values for the first angle 125 are implementation dependent, as discussed in connection with the embodiments of FIGS. 1A-1D. A practical range for the first angle 125 is at least zero degrees and less than 135 degrees with typical, preferred value being 90 degrees. A practical range for the second angle 130 is greater than or equal to 180 degrees and less than 270 degrees with typical, preferred value being 225 degrees.

FIG. 2D is a drawing of another embodiment of the device 100 of FIG. 2A for limiting the movement of one body in relation to another with minimum value of first angle 125 consistent with the teachings of the invention. In FIG. 2D, the first angle 125 is equal to zero degrees and the second angle 130 is 180 degrees.

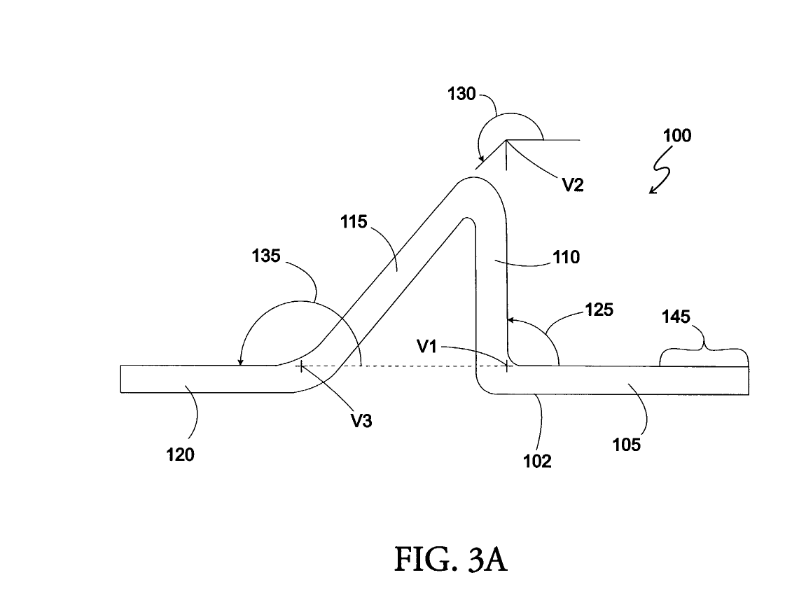

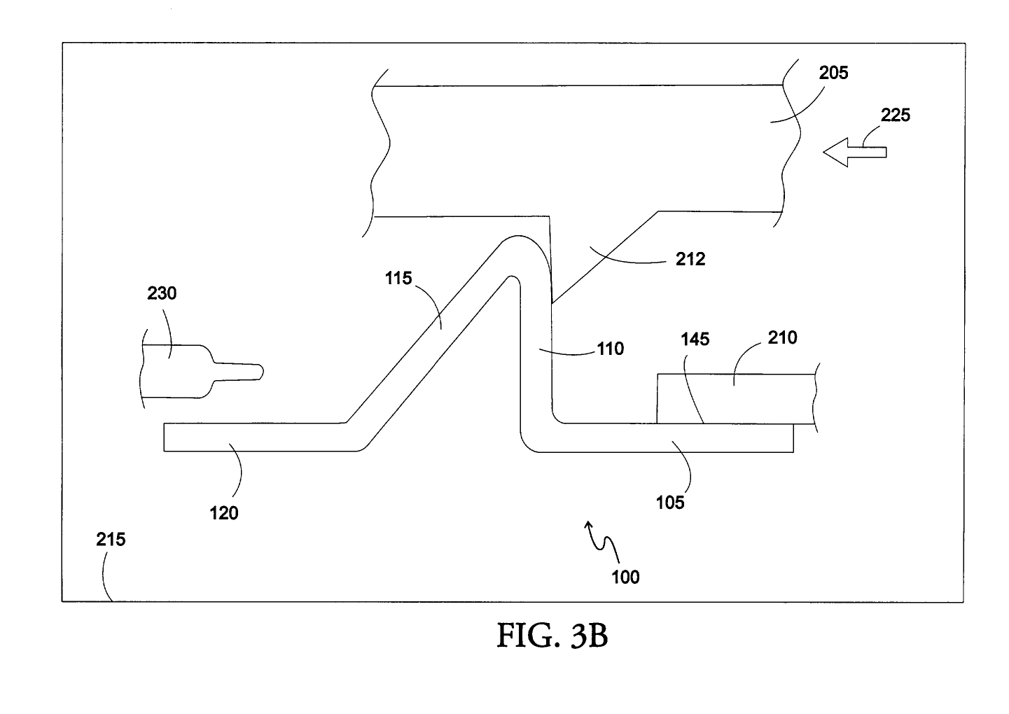

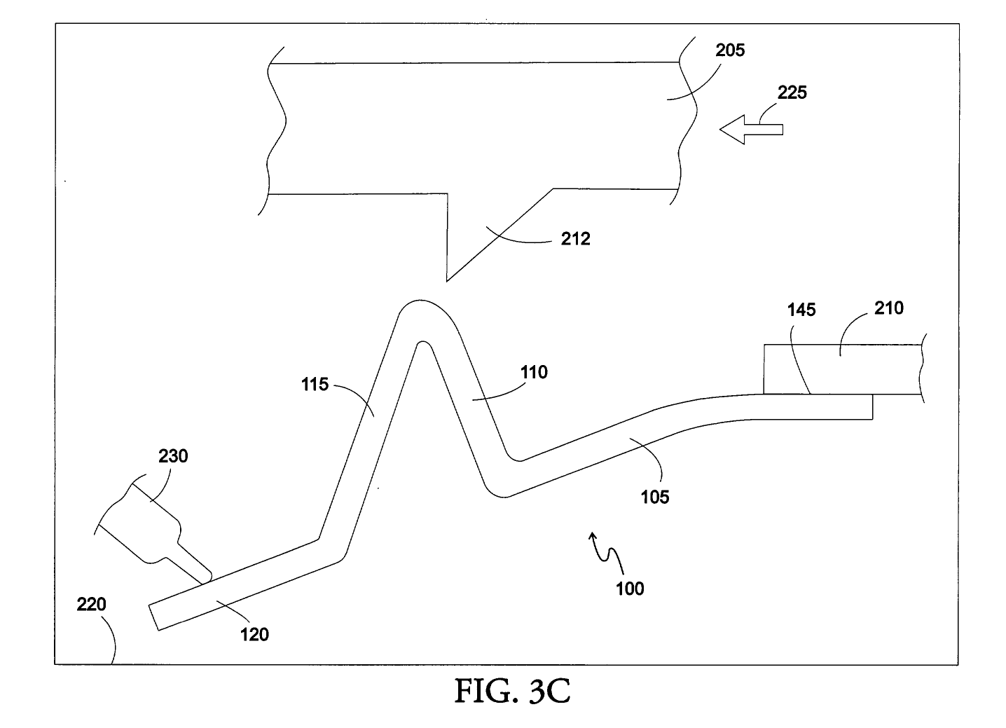

FIG. 3A is a drawing of a further embodiment of the device 100 for limiting the movement of one body in relation to another consistent with the teachings of the invention. In a third representative embodiment as shown in FIG. 3A, the device 100, also referred to herein as lock spring 100 and as interlock 100, comprises the piece 102 of material which again could be fabricated as a wire 102, sheet stainless spring steel 102, a band 102, a molded part 102, or the like. The piece 102 again comprises the first, second, and third sections 105,110,115 and in addition a fourth section 120. A distal portion of the first section 105 is referred to as the portion 145 in subsequent discussion.

In the un-deflected position of FIG. 3A, the first angle 125 is formed between first and second sections 105,110 with vertex at first vertex V1. The first angle 125 measured in a counter-clockwise direction from the first section 105. Also, in the un-deflected position of FIG. 3A, the second angle 130 is formed between parallel translation of the first section 105 and the third section 115 with vertex at second vertex V2. The second angle 130 measured in a counter-clockwise direction from the parallel translation of the first section 105. In addition, a third angle 135 is formed between parallel translation of the first section 105 and the fourth section 120 with vertex at third vertex V3. The third angle 135 is measured in a counter-clockwise direction from the parallel translation of the first section 105 at third vertex V3.

FIG. 3B is a drawing of the device 100 of FIG. 3A located in the first position 215 for limiting the movement of one body in relation to another as described in various representative embodiments consistent with the teachings of the invention. In the representative embodiment of FIG. 3B, the lock spring 100 shown is that of the third representative embodiment of FIG. 3A and is attached to the second body 210 at portion 145. The first body 205 comprising the stop 212 is prevented from motion in the preselected direction 225 past the lock spring 100 by the impact of stop 212 against the second section 110. In a typical application, the first body 205 is constrained to movement along the axis parallel to that of the preselected direction 225 by tracks attached to the second body 210. With the lock spring 100 in the first position 215 as shown in FIG. 3B, the first body 205 is free to move in the direction opposite to the preselected direction 225 until restricted by other components of the second body 210 not shown in the figures. Also shown in FIG. 3B is the tool 230, which could be, for example, screwdriver 230.

FIG. 3C is another drawing of the device 100 of FIG. 3A located in the second position 220 for limiting the movement of one body in relation to another as described in various representative embodiments consistent with the teachings of the invention. In FIG. 3C, the lock spring 100 has been moved to the second position 220 by the force applied by the tool 230 to the fourth section 120. In the second position 220, the second section 110 has been depressed far enough that it no longer impedes the movement of the first body 205 past the second body 210. For the third representative embodiment shown in FIG. 3A, the force used to move the lock spring 100 to the second position 220 is preferably applied to the fourth section 120.

Practical minimum and maximum values for first, second, and third angles 125,130,135 are implementation dependent. In general, however, characteristics of importance in the implementation are (1) for the lock spring 100 to impede, if not completely stop, motion of the first body 205 in the preselected direction 225 by impacting the stop 212, (2) for the tool 230 to be capable of accessing the fourth section 120 in order to deflect it from the first position 215 to the second position 220 when removing the first body 205 from its position relative to the second body 210, and (3) for the first body 205 to be able to move relatively freely in the opposite direction to that of the preselected direction 225 when replacing the first body 205 in position relative to the second body 210. The specific materials chosen for the stop 212 and for the lock spring 100, as well as the geometry chosen for the stop 212 will have a significant impact on the success in attaining the above important characteristics. In this embodiment, a practical range for the first angle 125 is at least zero degrees and less than 135 degrees with typical, preferred value being 90 degrees. A practical range for the second angle 130 is greater than or equal to 180 degrees and less than 270 degrees with typical, preferred value being 225 degrees. In addition, a practical range for the third angle 135 is greater than or equal to 135 degrees and less than 225 degrees with typical, preferred value being 180 degrees.

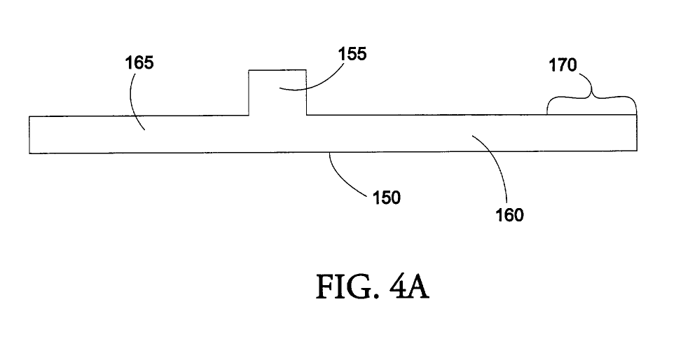

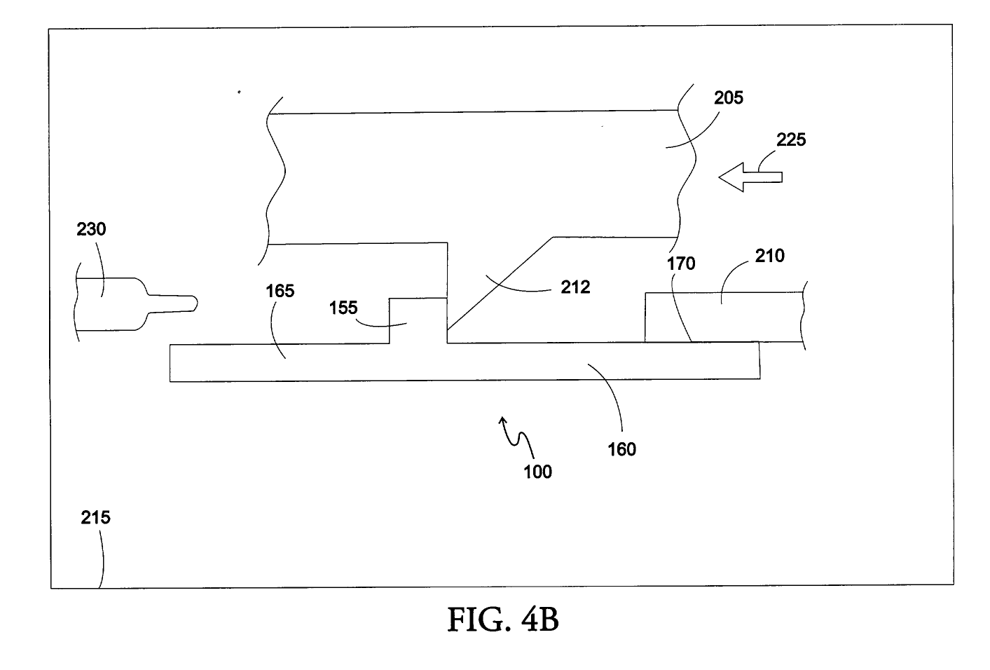

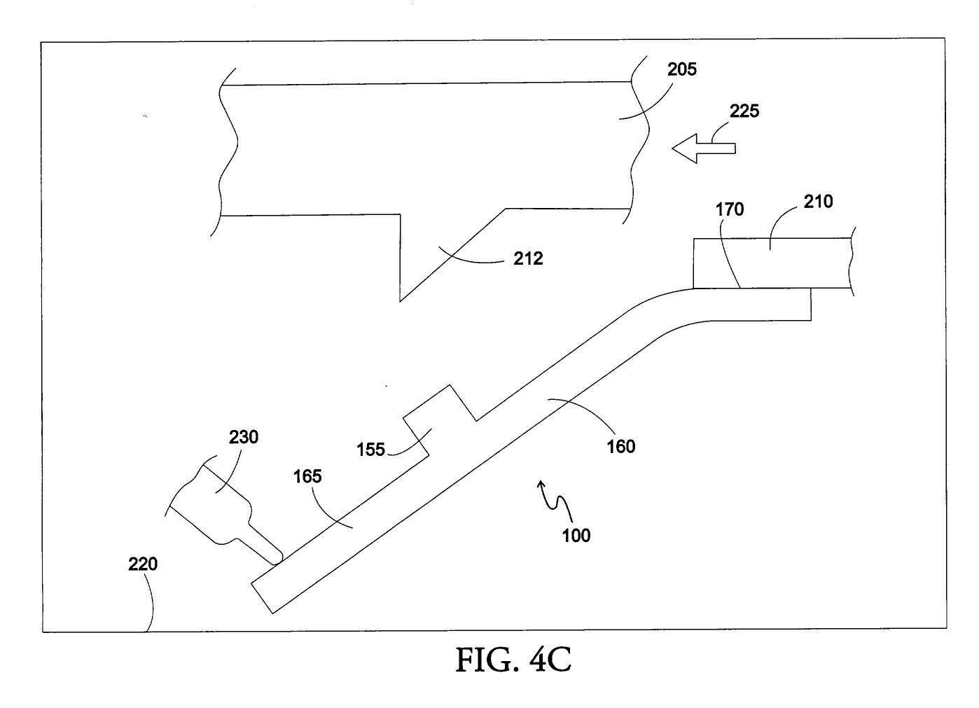

FIG. 4A is drawing of still another embodiment of the device 100 for limiting the movement of one body in relation to another consistent with the teachings of the invention. In a fourth representative embodiment as shown in FIG. 4A, the device 100, also referred to herein as lock spring 100 and as interlock 100, comprises a base 150 which could be fabricated as a wire 102, sheet stainless spring steel 102, a band 102, a molded part 102, or the like. The base 150 comprises a first and second segments 160,165 and has a protrusion 155 attached to it. The protrusion 155 could be formed by any of various means including, but not limited to, the forming of a kink on the base 150 wherein the base is a wire. The protrusion 155 could also be extruded from the base 150 wherein the base is a strip of material. A distal portion of the first segment 160 will be referred to as an area 170 in subsequent discussion.

FIG. 4B is a drawing of the device 100 of FIG. 4A located in the first position 215 for limiting the movement of one body in relation to another as described in various representative embodiments consistent with the teachings of the invention. In the representative embodiment of FIG. 4B, the lock spring 100 shown is that of the fourth representative embodiment of FIG. 4A and is attached to the second body 210 at area 170. The first body 205 comprising the stop 212 is prevented from motion in the preselected direction 225 past the lock spring 100 by the impact of stop 212 against the protrusion 155. In a typical application, the first body 205 is constrained to movement along an axis parallel to that of the preselected direction 225 by tracks attached to the second body 210. With the lock spring 100 in the first position 215 as shown in FIG. 4B, the first body 205 is free to move in the direction opposite to the preselected direction 225 until restricted by other components of the second body 210 not shown in the figures. A knowledge of these components is not necessary for an understanding of the invention. Also shown in FIG. 4B is the tool 230, which could be for example screwdriver 230.

FIG. 4C is another drawing of the device 100 of FIG. 4A located in the second position 220 for limiting the movement of one body in relation to another as described in various representative embodiments consistent with the teachings of the invention. In FIG. 4C, the lock spring 100 has been moved to the second position 220 by force applied by the tool 230 to the second segment 165. In the second position 220, the protrusion 155 has been depressed far enough that it no longer impedes the movement of the first body 205 past the second body 210.

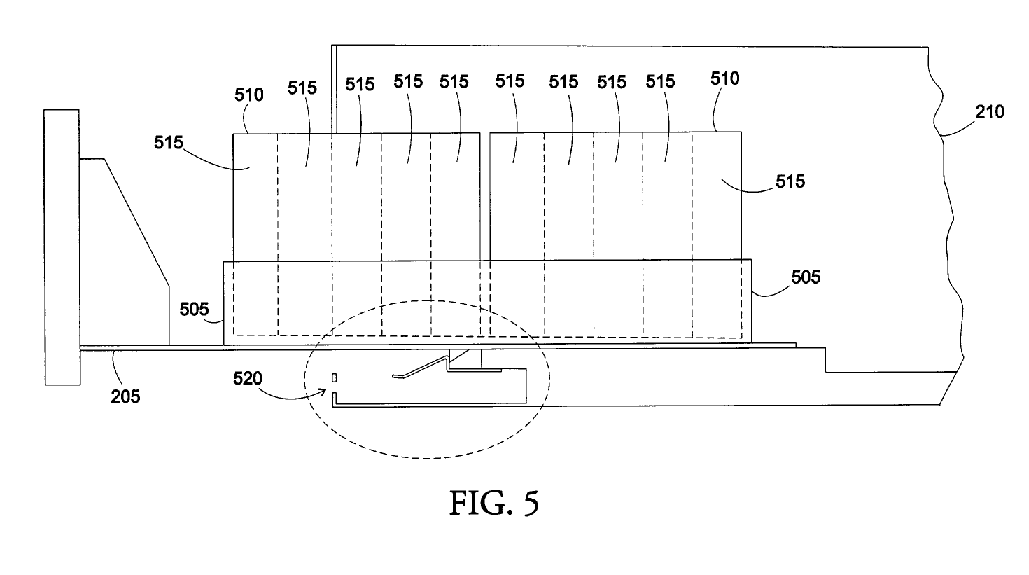

FIG. 5 is a drawing of an example application of an embodiment of the device 100 for limiting the movement of one body in relation to another consistent with the teachings of the invention. FIG. 5 shows the first body 205 which in this examples is the drawer 205 of an autochanger of a magnetic tape library used for data storage in computer systems. The drawer 205 contains a magazine tray 505 on which are loaded two tape magazines 510 each of which hold five tape cartridges 515 in this example. When the user desires to open the drawer 205, he does so by first requesting it via either the front panel of the autochanger or via the host computer. His request may include the movement of a specific tape cartridge 515 with associated magazine tray 505 to the drawer 205. The system then actuates a solenoid so that the drawer 205 can be partially opened providing access to the requested tape cartridge 515. As previously described, the lock spring 100 preferably inhibits complete removal of the drawer 205. For complete removal of the drawer 205, the lock spring 100 is first released via insertion of the tool into an opening 520.

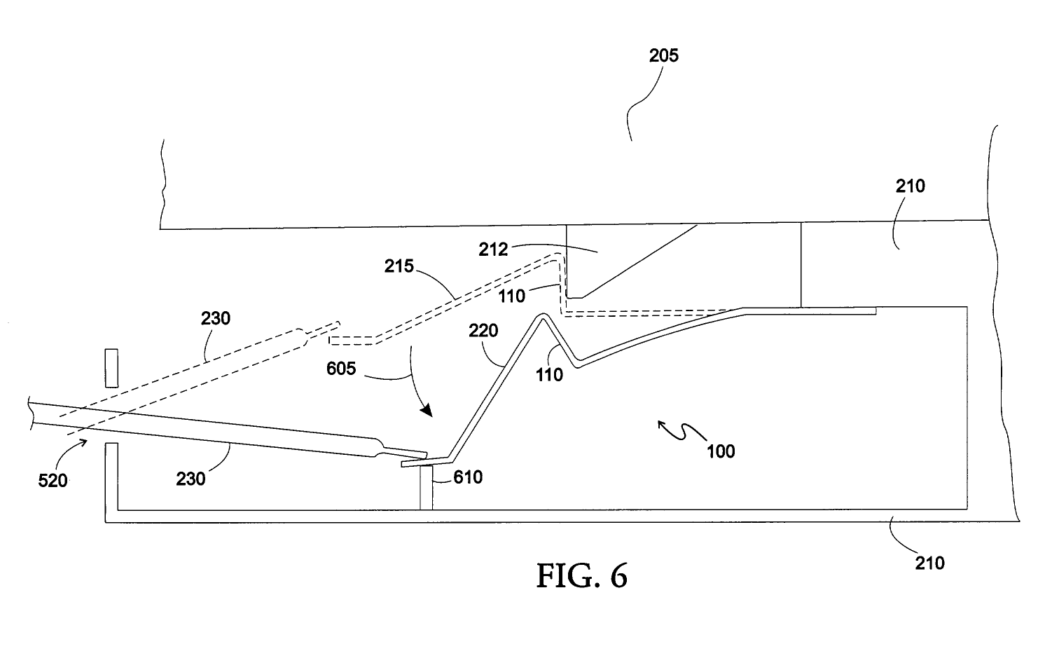

FIG. 6 is another drawing of the example application of FIG. 5 of the device 100 for limiting the movement of one body in relation to another as described in various representative embodiments consistent with the teachings of the invention. FIG. 6 is a drawing of the detail indicated in FIG. 5. FIG. 6 shows the lock spring 100 in first and second positions 215,220. In the first position 215, the impact of the stop 212 against the second section 110 of the lock spring 100 prevents complete removal of the drawer 205 from the tape changer. To enable complete removal of the drawer 205, the tool 230 is inserted into the opening 520 and then forces the lock spring 100 to rotate as indicated by rotation arrow 605 from the first position 215 to the second position 220. Rotation is stopped by means of a rotation stop 610. In the second position 220, the second section 110 is moved such that it no longer impedes the movement of the drawer 205 with respect to the chassis 210 and can be completely removed from the autochanger chassis 210.

A primary advantage of the embodiment as described in the present patent document over prior lock springs and interlocking mechanisms is its simplicity and the fact that it can be fabricated inexpensively.

What is claimed is:

1. A device for limiting the movement of a first body in relation to a second body, comprising:
a bendable piece of material, wherein the piece comprises a first section and a second section contiguous to the first section, wherein the second section forms a first angle with respect to the first section, wherein the first angle is measured in a counter-clockwise direction from the first section, wherein the first angle is at least zero degrees and is less than 135 degrees when the piece is un-deflected, and wherein at least a portion of the first section is attachable to the second body.

2. The device as recited in claim 1, wherein the piece is selected from the group consisting of wire, sheet stainless spring steel, a band, and a molded part.

3. The device as recited in claim 1, wherein the portion of the first section is attached to the second body, wherein the piece is positioned in a first position relative to the second body, and wherein when the piece is positioned in the first position the second section prevents movement in a preselected direction of the first body past the second section.

4. The device as recited in claim 3, wherein a force applied to the second section positions the piece in a second position relative to the second body and wherein when the piece is positioned in the second position the first body is capable of unrestricted motion past the second section in the preselected direction.

5. The device as recited in claim 3, wherein movement of the piece from the first position to the second position occurs in a plane substantially perpendicular to a plane which includes the first angle.

6. The device as recited in claim 1, wherein the piece further comprises a third section, wherein the third section is contiguous to the second section, wherein the third section forms a second angle with parallel translation of the first section, wherein vertex of the second angle is located where the second section and the third section are contiguous, wherein the second angle is measured in a counter-clockwise direction from the parallel translation of the first section, and wherein the second angle is at least 190 degrees and is less than 270 degrees when the piece is un-deflected.

7. The device as recited in claim 6, wherein movement of the piece from the first position to the second position occurs in a plane substantially perpendicular to a plane which includes the first and second angles.

8. The device as recited in claim 6, wherein the piece further comprises a fourth section, wherein the fourth section is separately contiguous to the third section, wherein the fourth section forms a third angle with parallel translation of the first section, wherein vertex of the third angle is located where the third section and the fourth section are contiguous, wherein the third angle is measured in a counter-clockwise direction from the parallel translation of the first section, and wherein the third angle is at least 135 degrees and is less than 225 degrees when the piece is un-deflected.

9. A device for limiting the movement of a first body in relation to a second body, comprising:
a bendable piece, wherein the piece comprises a base and a protrusion connected to the base, wherein the base comprises a first segment and a second segment, and wherein at least a portion of the first segment is attachable to the second body.

10. The device as recited in claim 9, wherein the piece is selected from the group consisting of wire, sheet stainless spring steel, a band, and a molded part.

11. The device as recited in claim 9, wherein the portion of the first segment is attached to the second body, wherein the piece is positioned in a first position relative to the second body, and wherein when the piece is positioned in the first position the protrusion prevents movement in a preselected direction of the first body past the protrusion.

12. The device as recited in claim 11, wherein a force applied to the second segment positions the piece in a second position relative to the second body and wherein when the piece is positioned in the second position the first body is capable of unrestricted motion past the protrusion in the preselected direction.

13. The device as recited in claim 12, wherein movement of the piece from the first position to the second position occurs in a plane substantially perpendicular to a plane which includes the first segment and the protrusion.
